(19) United States
(12) Patent Application Publication
(10) Pub. No.: US 2008/0006158 A1
(43) Pub. Date: Jan. 10, 2008

(54) Air cleaner and air cleaner diagnostic process

(75) Inventors: Bruce Kiern, Gulfport, MS (US); Christopher M. Paterson, Biloxi, MS (US); John Relman Bohlen, Gulfport, MS (US)

Correspondence Address: THE OLLILA LAW GROUP LLC, 2060 BROADWAY, SUITE 300, BOULDER, CO, 80302, US

(73) Assignee: Oreck Holdings, LLC

(21) Appl. No.: 11/481,376

(22) Filed: Jul. 5, 2006

(51) Int. Cl. B01D 46/00

(52) U.S. Cl. 96/417; 55/471

(57) ABSTRACT

An air cleaner is provided according to the invention. The air cleaner includes a printed circuit board (PCB) configured to operate the air cleaner and a diagnostics circuit. The diagnostics circuit is configured to receive a predetermined diagnostic initiation sequence in the air cleaner, initiate a diagnostics process for one or more operational features of the air cleaner in response to the predetermined diagnostic initiation sequence, and generate a diagnostics determination as a result of the diagnostics process.

### TECHNICAL FIELD

The present invention relates to an air cleaner, and more particularly, to an air cleaner and air cleaner diagnostic process.

### BACKGROUND OF THE INVENTION

Air cleaners are widely used in home and office settings for cleaning the air. An air cleaner can filter the air in order to remove airborne contaminants. An air cleaner can therefore include any type of mechanical filter element comprising a mesh, a weave, a foam, etc. An air cleaner can further include electrical air cleaning components, including ionizers, electrostatic precipitators, etc.

With advancements in technology, room air cleaners are becoming increasingly complex. An air cleaner may include multiple electronic components, including an electric motor, sensors, an ionizer, an electrostatic precipitator, etc., and associated circuitry. As a result, the associated circuitry is also becoming increasingly complex.

Problems exist in the manufacturing and assembly of prior art air cleaners. The large number of air cleaner functions and the large number of air cleaner components result in a greater likelihood of warranty issues. Therefore, it is desirable that completed air cleaners (and components thereof) are fully and satisfactorily functioning when the unit leaves the factory. It is desirable that completed air cleaners are capable of being quickly and efficiently tested.

### SUMMARY OF THE INVENTION

An air cleaner is provided according to an embodiment of the invention. The air cleaner comprises a printed circuit board (PCB) configured to operate the air cleaner and a diagnostics circuit. The diagnostics circuit is configured to receive a predetermined diagnostic initiation sequence in the air cleaner, initiate a diagnostics process for one or more operational features of the air cleaner in response to the predetermined diagnostic initiation sequence, and generate a diagnostics determination as a result of the diagnostics process.

An air cleaner diagnostic process is provided according to an embodiment of the invention. The diagnostic process comprises receiving a predetermined diagnostic initiation sequence in the air cleaner, initiating a diagnostics process for one or more operational features of the air cleaner in response to the predetermined diagnostic initiation sequence, and generating a diagnostics determination as a result of the diagnostics process.

An air cleaner diagnostic process is provided according to an embodiment of the invention. The diagnostic process comprises receiving a predetermined diagnostic initiation sequence in the air cleaner and initiating a diagnostics process for one or more operational features of the air cleaner in response to the predetermined diagnostic initiation sequence. The method further comprises generating a positive diagnostics determination if the one or more operational features are operating within predetermined parameters and generating a negative diagnostics determination if an operational feature of the one or more operational features is operating outside the predetermined parameters.

### BRIEF DESCRIPTION OF THE DRAWINGS

The same reference number represents the same element on all drawings. It should be noted that the drawings are not necessarily to scale.

FIG. 1 shows an air cleaner according to an embodiment of the invention.

FIG. 2 shows detail of the control panel according to an embodiment of the invention.

FIG. 3 shows the air cleaner according to an embodiment of the invention.

FIG. 4 is a flowchart of an air cleaner diagnostic process according to an embodiment of the invention.

FIG. 5 is a flowchart of an air cleaner diagnostic process according to an embodiment of the invention.

### DETAILED DESCRIPTION OF THE INVENTION

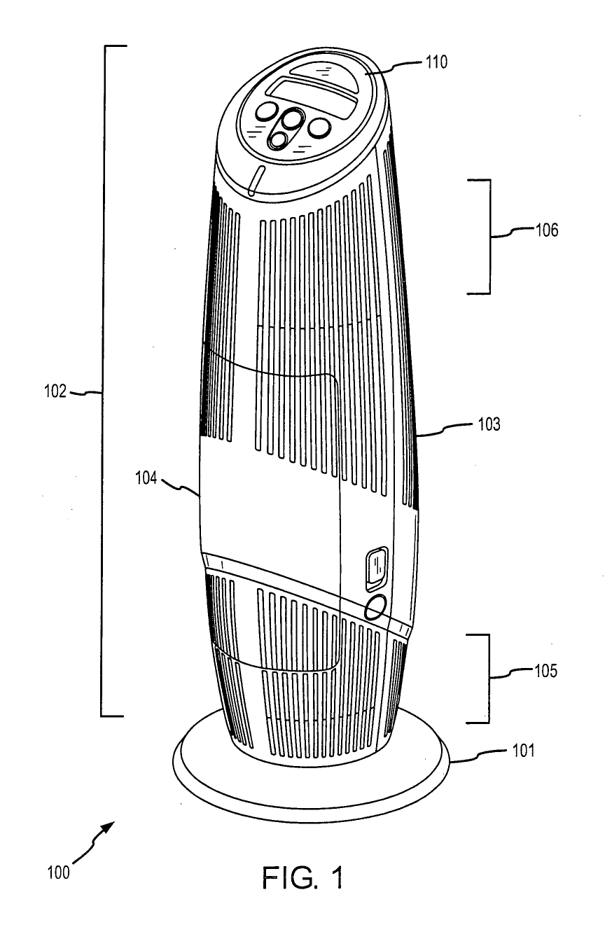

FIGS. 1-5 and the following descriptions depict specific embodiments to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will also appreciate that the features described below can be combined in various ways to form multiple variations of the invention. As a result, the invention is not limited to the specific embodiments described below, but only by the claims and their equivalents.

FIG. 1 shows an air cleaner 100 according to an embodiment of the invention. The air cleaner 100 in the embodiment shown includes a base portion 101 and a tower portion 102. The tower portion 102 can be generally vertically positioned and elongate in shape. In one embodiment, the tower portion 102 can be substantially cylindrical in shape. However, it should be understood that the air cleaner 100 can comprise any configuration, such as substantially rectangular, substantially round, a tower, etc. The air cleaner 100 can comprise a floor air cleaner model, a table top air cleaner model, a portable or personal air cleaner model, etc.

The tower portion 102 includes an external shell 103, one or more doors 104, and a control panel 110. The tower portion 102 further includes an air inlet 105 and an air outlet 106. Air is drawn in through the air inlet 105, is cleaned inside the tower portion 102, and the cleaned air is exhausted from the air outlet 106. However, it should be understood that the air cleaner 100 can comprise other shapes, configurations, and designs, and the tower configuration is shown merely for illustration.

The air inlet 105 is shown as being at the lower end of the tower portion 102. However, it should be understood that alternatively the relative positions of the air inlet 105 and the air outlet 106 could be interchanged.

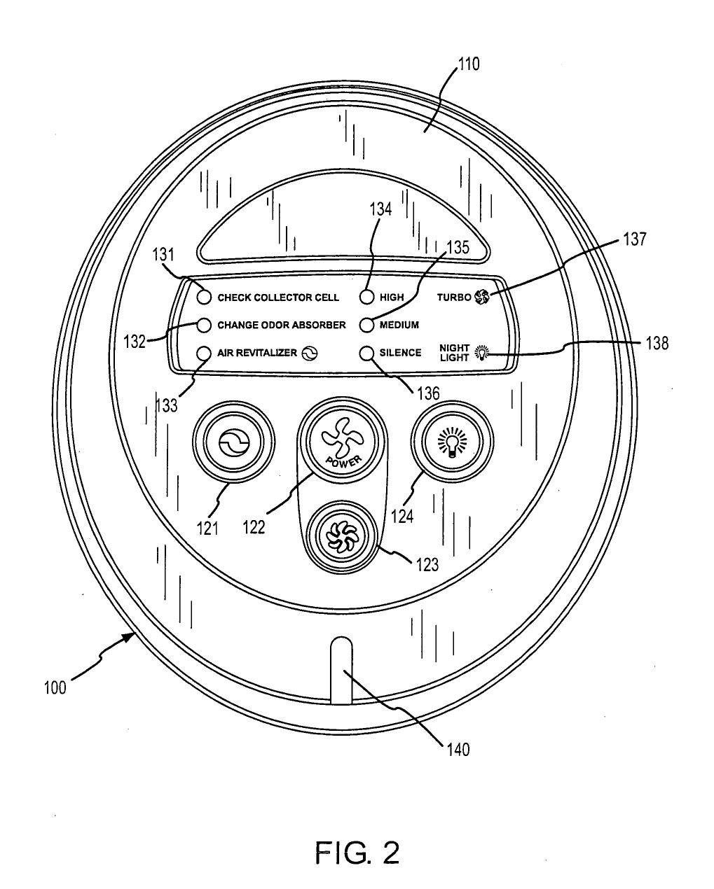

FIG. 2 shows detail of the control panel 110 according to an embodiment of the invention. The control panel 110 includes various controls, including an air revitalizer (i.e., ionizer) button 121, a fan power button 122, a fan turbo button 123, and a nightlight button 124. Other controls are contemplated and are within the scope of the description and claims. In addition, other control types, such as sliders, switches, touch sensors, optical sensors, etc., are contemplated and are within the scope of the description and claims.

Pressing the air revitalizer button 121 turns the air revitalizer on and off. Pressing the fan power button 122 cycles the fan of the air cleaner 100 through the fan power levels. To turn the air cleaner 100 on, the user presses the fan power button 122 once. Power comes on in the low i.e., “silence” setting. Subsequent presses of the fan power button 122 transitions the fan to the medium speed, to the high speed, and then turns the fan off. The electrostatic precipitator cell is turned on when the fan is running at any speed. Pressing the fan turbo button 123 runs the fan at its highest speed, the turbo speed. This speed setting is accompanied by illumination of the turbo fan speed indicator 137. The electrostatic precipitator is on when the fan is at the turbo speed setting. The turbo speed setting can be turned off by a subsequent press of the fan turbo button 123 or by cycling off the power of the air cleaner 100, for example.

The control panel further includes various visual indicators, including a check collector cell indicator 131, a change odor absorber indicator 132, an air revitalizer indicator 133, a high fan speed indicator 134, a medium fan speed indicator 135, a silence fan speed indicator 136, a turbo fan speed indicator 137, and a nightlight indicator 138.

The check collector cell indicator 131 is generally illuminated when a collector cell (i.e., electrostatic precipitator) of the air cleaner 100 is dirty and requires cleaning. The collector cell may require cleaning after a predetermined number of hours of operation, for example. The check collector cell indicator 131 can be illuminated when a corresponding collector cell timer indicates that a predetermined time period has elapsed.

The change odor absorber indicator 132 is generally illuminated when an odor absorber requires replacement. The odor absorber may require replacement when an odor absorber material has been consumed or effectively clogged up. The change odor absorber indicator 132 can be illuminated when a corresponding odor absorber timer indicates that a predetermined time period has elapsed.

The air revitalizer indicator 133 is generally illuminated when the air revitalizer (i.e., air ionizer) is operating and ionizing airflow through the air cleaner 100. The air revitalizer indicator 133 is correspondingly turned on and off when the air revitalizer is turned on and off.

The high fan speed indicator 134 is generally illuminated during a high fan output setting. The high indicator 134 is correspondingly turned on and off when the high fan output setting is turned on and off.

The medium fan speed indicator 135 is generally illuminated during a medium fan output setting. The medium indicator 135 is correspondingly turned on and off when the medium fan output setting is turned on and off.

The silence fan speed indicator 136 is generally illuminated during a lowest fan output setting. The silence mode of the air cleaner 100 is therefore relatively quiet. The silence fan speed indicator 136 is correspondingly turned on and off when the silence fan output setting is turned on and off.

The turbo fan speed indicator 137 is generally illuminated during turbo mode operation of a fan motor (or motors). The turbo mode is a highest fan output setting. In some embodiments, the turbo mode is automatically controlled by the air cleaner 100, and cannot be activated by a person. The turbo fan speed indicator 137 is correspondingly turned on and off when the turbo fan output setting is turned on and off.

The nightlight indicator 138 is generally illuminated when a nightlight 140 (see below) is activated. The nightlight indicator 138 is correspondingly turned on and off when the nightlight 140 is turned on and off.

The air cleaner 100 further includes a nightlight 140. The nightlight 140 in the embodiment shown is positioned at or near the top of the tower portion 102 of the air cleaner 100. Consequently, the nightlight 140 is substantially adjacent to the control panel 110. The nightlight 140 in some embodiments is substantially elongate in shape, as shown. However, it should be understood that the nightlight 140 can comprise any shape and size.

The nightlight 140 can perform as a typical nightlight. The nightlight 140 generates light and at least partially illuminates a surrounding area. The nightlight 140 can further illuminate the control panel 110 and enable a person to find the buttons at night.

When the nightlight button 124 is pushed, the nightlight 140 is turned on. In addition, the nightlight indicator 138 is illuminated. A subsequent press of the nightlight button 124 turns off the nightlight 140 and the nightlight indicator 138.

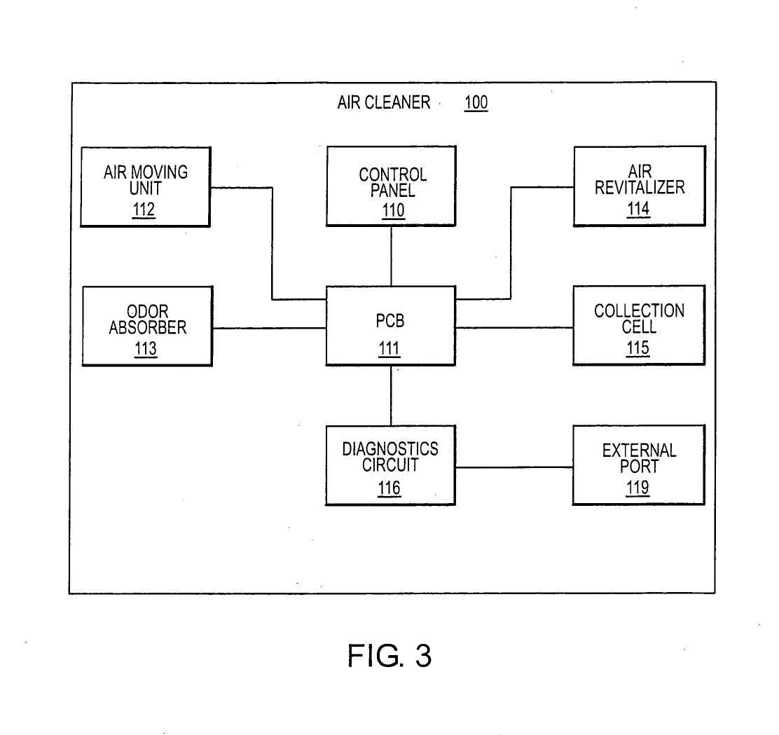

FIG. 3 shows the air cleaner 100 according to an embodiment of the invention. In this embodiment, the air cleaner 100 includes the control panel 110 connected to a printed circuit board (PCB) 111. The PCB 111 operates various components of the air cleaner 100. In the embodiment shown, the PCB 111 is connected to and operates an air moving unit 112, an odor absorber 113, an air revitalizer 114, and a collection cell 115.

The air moving unit 112 can comprise one or more motors and fans for generating an airflow. The odor absorber 113 removes odors from the airflow. The odor absorber 113 can include a switch or other sensor that indicates when an odor absorber element is in place and properly seated in the air cleaner 100. The air revitalizer 114 ionizes the airflow. The collection cell 115 removes dirt and debris from the airflow by means of a high voltage electric field. The collection cell 115 can include a switch or other sensor that indicates when the collection cell element is in place and properly seated in the air cleaner 100.

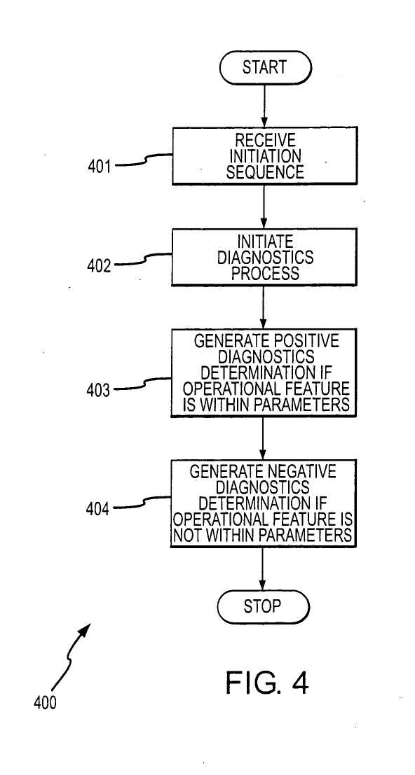

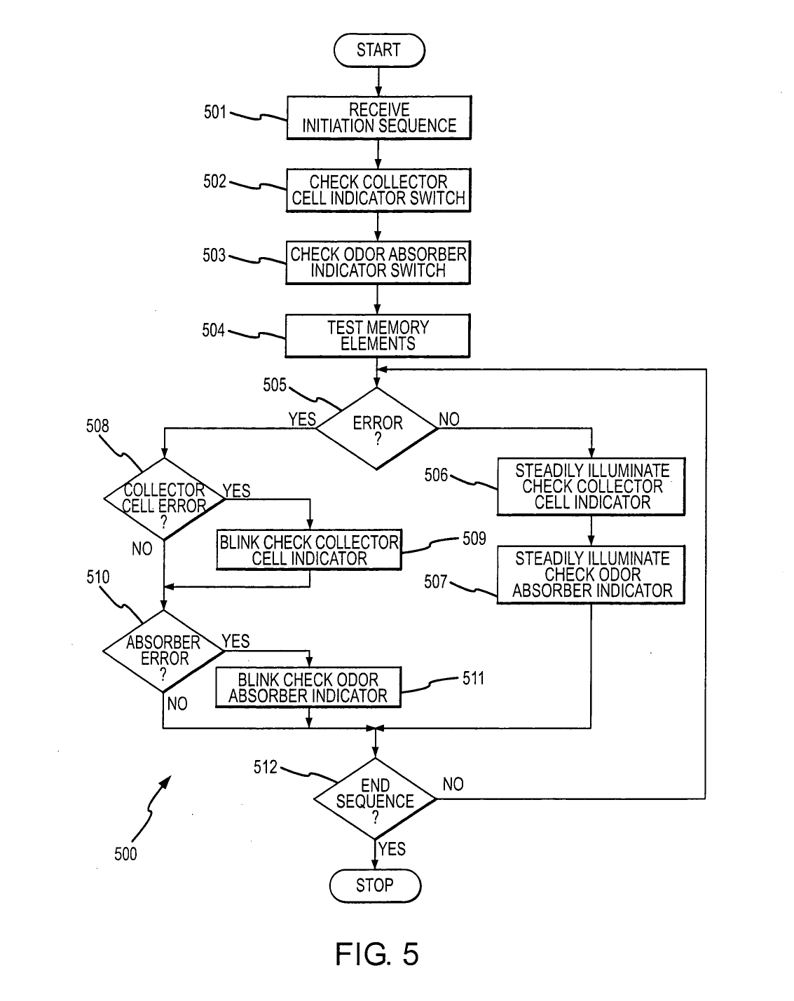

The air cleaner 100 can further include a diagnostics circuit 116. The diagnostics circuit 116 can run a diagnostics process and determine whether the air cleaner 100 is operating within predetermined parameters (see FIGS. 4-5 and the accompanying discussions). The diagnostics circuit 116 is connected to at least the PCB 111, and can optionally be directly connected to any of the other components. Consequently, the diagnostics circuit 116 can run diagnostics routines on the PCB 111. Further, the diagnostics circuit 116 can run diagnostics routines on other components, through the PCB 111. Alternatively, the diagnostics circuit 116 can be part of the PCB 111.

The diagnostics circuit 116 can perform a diagnostics process for one or more operational features of the air cleaner 100. The diagnostics circuit 116 can generate a positive or negative (i.e., successful or unsuccessful) diagnostics determination as a result of the diagnostics process and based on the outcome of the diagnostics process. If all operational features are within predetermined parameters, then the diagnostics circuit 116 generates a positive diagnostics determination. If one or more operational features are outside of the predetermined parameters, then the diagnostics circuit 116 generates a negative diagnostics determination.

The diagnostics process is initiated when a predetermined diagnostic initiation sequence is received in the air cleaner 100. The predetermined diagnostic initiation sequence can include a predetermined control combination, such as a predetermined button press combination. The predetermined diagnostic initiation sequence can include the provision of electrical power to the air cleaner 100, for example. In one embodiment, the predetermined diagnostic initiation sequence comprises activating the air revitalizer button 121 and the nightlight button 124 and providing electrical power to the air cleaner 100. This initiation sequence is provided for illustration, and is not limiting. Other initiation sequences are contemplated and are within the scope of the description and claims.

The diagnostics determination generated by the diagnostics circuit 116 can be stored by the air cleaner 100. The diagnostics determination can be stored by the diagnostics circuit 116 or by the PCB 111. In addition, the diagnostics determination can be outputted from the air cleaner 100. The diagnostics determination can be externally read out, such as through an external port 119, for example.

The diagnostics determination can be displayed through the control panel 110. In one embodiment, a first display is generated for a positive diagnostics determination and a second display is generated for a negative diagnostics determination. The display of the diagnostics determination can include generation of a visual display, including an alphanumeric display, and indicator light display, etc. In one embodiment, one or more predetermined indicator lights are illuminated.

The operational features can include proper operation of the PCB 111. In addition, the operational features can include whether the collection cell 115 is installed and whether the odor absorber 113 is installed. The operational features can include whether write operations to a memory are correctly performed.

The diagnostic process can compare one or more current operating values to one or more predetermined operating value ranges. For example, the air cleaner 100 can store operating currents and voltages of the collection cell 115 (including for a pre-ionizer stage, if applicable). These stored values can be read out by the diagnostics process and compared to acceptable current and voltage ranges. If an operating current or voltage exceeds an acceptable value, then the diagnostics process can determine an error. For example, the diagnostics process can determine an error if the operating current of the collection cell 115 has grown larger and larger over time, such as where the collection cell 115 is very dirty or where there is a mechanical malfunction in the collection cell 115.

FIG. 4 is a flowchart 400 of an air cleaner diagnostic process according to an embodiment of the invention. In step 401, an initiation sequence is received. The diagnostic process is triggered by receipt of the initiation sequence. The initiation sequence comprises a predetermined sequence of actions that must be correctly performed in order to initiate the diagnostic process, as previously discussed. In one embodiment, the initiation sequence comprises a user or operator pressing and holding one or more predetermined air cleaner buttons while the air cleaner 100 is unpowered, then providing the air cleaner 100 with a electrical power (e.g., connecting the air cleaner 100 to a wall socket, for example) while holding down the predetermined buttons. In one embodiment, the one or more predetermined buttons comprise the air revitalizer button 121 and the nightlight button 124. However, it should be understood that other buttonpress combinations and/or other power manipulations are contemplated and are within the scope of the description and claims.

In step 402, as a result of receiving the initiation sequence, the diagnostic process is initiated. The diagnostic process can check any manner of operational feature or features of the air cleaner 100. The diagnostic process can check operational features for errors or problems, as previously discussed, including checking for circuitry problems and checking that critical components of the air cleaner are in place and are properly seated.

In step 403, if the operational feature (or features) is within predetermined parameters, then a positive diagnostics determination is generated. The negative diagnostics determination can include generating a negative diagnostics display. For example, in the negative diagnostics display, a first indicator display can be illuminated. The first indicator display can comprise a predetermined control panel indicator or indicators. The first indicator display can comprise a predetermined display pattern, such as steady illumination of selected indicators, for example. In one embodiment, the first indicator display comprises steady illumination of the check collector cell indicator 131 and the change odor absorber indicator 132. The steady illumination indicates that no errors were found by the diagnostic process.

The predetermined parameters can include any manner of true/false states, thresholds, or ranges. If the operation feature is within the predetermined parameters, then the operational feature can be judged to be operating properly.

In step 404, if the operational feature (or features) is not within the predetermined parameters, then a negative diagnostics determination is generated. The negative diagnostics determination can include generating a negative diagnostics display. For example, in the negative diagnostics display a second indicator display can be illuminated. As before, the second indicator display can comprise a predetermined control panel indicator or indicators and can comprise a predetermined display pattern, such as blinking illumination of selected indicators to signal an error condition, for example. In one embodiment, the second indicator display comprises blinking illumination of the check collector cell indicator 131 (indicating collector cell not in position), blinking illumination of the change odor absorber indicator 132 (indicating odor absorber not in place), or blinking illumination of both (indicating memory write error of the two switch states).

FIG. 5 is a flowchart 500 of an air cleaner diagnostic process according to an embodiment of the invention. In step 501, an initiation sequence is received, as previously discussed.

In step 502, a collector cell indicator switch is checked. If the switch state reflects that the collector cell is not in place (either absent or not properly seated), then a collector cell error is determined to exist.

In step 503, an odor absorber indicator switch is check. If the switch state reflects that the odor absorber is not in place (either absent or not properly seated), then an odor absorber error is determined to exist.

In step 504, predetermined memory elements are tested. This step verifies that writes to memory are being correctly performed. In some embodiments, air cleaner switch states are written to a programmable read-only memory (PROM), such as an electrically erasable programmable read-only memory (EEPROM), for example. Because a write operation in such a memory can typically take 10 to 20 milliseconds to perform, it is desirable to test for and verify a successful write operation. In one embodiment, test values can be written to memory locations such as timers, for example. A read out of the written-to memory location is done to verify the write process.

In step 505, if no errors were detected by the diagnostic process, then the process branches to step 506. If one or more errors were detected by the diagnostic process, then the process branches to step 508.

In step 506, because there were no errors detected by the diagnostics process, the check collector cell indicator 131 is steadily illuminated. The steady illumination of the check collector cell indicator 131 indicates an absence of error. The check collector cell indicator 131 can be illuminated for a predetermined time period, such as several seconds, for example.

In step 507, the change odor absorber indicator 132 is steadily illuminated. The steady illumination of the change odor absorber indicator 132 indicates an absence of error. The change odor absorber indicator 132 can be illuminated for a predetermined time period, such as several seconds, as previously discussed. Therefore, the positive diagnostics display in this embodiment comprises steady illumination of a first indicator light for a first time period followed by steady illumination of a second indicator light for a second time period.

In step 508, if the error included a collector cell error, then the process branches to step 509. Otherwise, the process proceeds to step 510.

In step 509, because a collector cell error has been determined, the air cleaner 100 blinks the check collector cell indicator 131. The blinking of the check collector cell indicator 131 indicates a collector cell problem to a user. The blinking can be at a predetermined rate and for a predetermined time. Alternatively, the blinking can continue for as long as the air cleaner 100 is in the diagnostic mode.

In step 510, if the error included an odor absorber error, then the process branches to step 511. Otherwise, the process proceeds to step 512.

In step 511, because an odor absorber error has been determined, the air cleaner 100 blinks the change odor absorber indicator 132. The blinking of the change odor absorber indicator 132 indicates an odor absorber problem to a user. The blinking can be at a predetermined rate and for a predetermined time. Alternatively, the blinking can continue for as long as the air cleaner 100 is in the diagnostic mode, as previously discussed.

In step 512, the diagnostic process waits for an end sequence. The end sequence can comprise a predetermined buttonpress sequence or a loss of power to the air cleaner 100. When the end sequence is detected, the diagnostic process is exited. In some embodiments, the end sequence can comprise turning off the air cleaner 100, removing electrical power from the air cleaner 100, or pressing and holding the nightlight button 124 and/or the air revitalizer button 121. However, other end sequences are contemplated and are within the scope of the description and claims.

What is claimed is:

1. An air cleaner, comprising:
a printed circuit board (PCB) configured to operate the air cleaner; and
a diagnostics circuit, with the diagnostics circuit being configured to receive a predetermined diagnostic initiation sequence in the air cleaner, initiate a diagnostics process for one or more operational features of the air cleaner in response to the predetermined diagnostic initiation sequence, and generate a diagnostics determination as a result of the diagnostics process.

2. The air cleaner of claim 1, with the diagnostics determination comprising a positive diagnostics determination if the one or more operational features are operating within predetermined parameters.

3. The air cleaner of claim 1, with the diagnostics determination comprising a negative diagnostics determination if an operational feature of the one or more operational features is operating outside the predetermined parameters.

4. The air cleaner of claim 1, with the predetermined diagnostic initiation sequence comprising an external command.

5. The air cleaner of claim 1, with the predetermined diagnostic initiation sequence comprising a predetermined control sequence.

6. The air cleaner of claim 1, with the predetermined diagnostic initiation sequence comprising a predetermined control sequence combined with provision of electrical power to the air cleaner.

7. The air cleaner of claim 1, with the diagnostics circuit being further configured to store the positive diagnostics determination.

8. The air cleaner of claim 1, with the diagnostics circuit being further configured to generate a positive diagnostics display if the diagnostics circuit generates the positive diagnostics determination.

9. The air cleaner of claim 1, with the diagnostics circuit being further configured to generate a first positive diagnostics display for a first predetermined successful time period if the diagnostics circuit generates the positive diagnostics determination and generate a second positive diagnostics display for a second predetermined successful time period after generating the first positive diagnostics display.

10. The air cleaner of claim 1, with the diagnostics circuit being further configured to illuminate a first positive diagnostics indicator for a first predetermined successful time period if the diagnostics circuit generates the positive diagnostics determination and illuminate a second positive diagnostics indicator for a second predetermined successful time period after illuminating the first positive diagnostics indicator.

11. The air cleaner of claim 1, with the diagnostics circuit being further configured to illuminate a check collector cell indicator for a first predetermined successful time period if the diagnostics circuit generates the positive diagnostics determination and illuminate a change odor absorber indicator for a second predetermined successful time period after illuminating the check collector cell indicator.

12. The air cleaner of claim 1, with the diagnostics circuit being further configured to generate a negative diagnostics determination if an operational feature of the one or more operational features is operating outside the predetermined parameters.

13. The air cleaner of claim 1, with the diagnostic process checking for proper operation of a printed circuit board (PCB) of the air cleaner.

14. The air cleaner of claim 1, with the diagnostic process comparing one or more current operating values to one or more predetermined operating value ranges.

15. The air cleaner of claim 1, with the diagnostic process checking for one or more correct write operations to a memory.

16. The air cleaner of claim 1, with the diagnostic process checking for one or more correct write operations to a programmable read-only memory (PROM).

17. The air cleaner of claim 1, with the diagnostic process checking for one or more correct write operations to a programmable read-only memory (PROM) by a check collector cell indicator switch and by a change odor absorber indicator switch.

18. The air cleaner of claim 1, with the diagnostic process checking whether a collection cell is installed.

19. The air cleaner of claim 1, with the diagnostic process checking whether an odor absorber is installed.

20. An air cleaner diagnostic process, comprising:
receiving a predetermined diagnostic initiation sequence in the air cleaner;
initiating a diagnostics process for one or more operational features of the air cleaner in response to the predetermined diagnostic initiation sequence; and
generating a diagnostics determination as a result of the diagnostics process.

21. The method of claim 20, with generating the diagnostics determination comprising generating a positive diagnostics determination if the one or more operational features are operating within predetermined parameters.

22. The method of claim 20, with generating the diagnostics determination comprising generating a negative diagnostics determination if an operational feature of the one or more operational features is operating outside the predetermined parameters.

23. The method of claim 20, with the predetermined diagnostic initiation sequence comprising an external command.

24. The method of claim 20, with the predetermined diagnostic initiation sequence comprising a predetermined control sequence.

25. The method of claim 20, with the predetermined diagnostic initiation sequence comprising a predetermined control sequence combined with provision of electrical power to the air cleaner.

26. The method of claim 20, with the method further comprising storing the positive diagnostics determination.

27. The method of claim 20, with the method further comprising generating a positive diagnostics display if the positive diagnostics determination is generated.

28. The method of claim 20, with the method further comprising generating a first positive diagnostics display for a first predetermined successful time period if the positive diagnostics determination is generated and generating a second positive diagnostics display for a second predetermined successful time period after generating the first positive diagnostics display.

29. The method of claim 20, with the method further comprising illuminating a first positive diagnostics indicator for a first predetermined successful time period if the positive diagnostics determination is generated and illuminating a second positive diagnostics indicator for a second predetermined successful time period after illuminating the first positive diagnostics indicator.

30. The method of claim 20, with the method further comprising illuminating a check collector cell indicator for a first predetermined successful time period if the positive diagnostics determination is generated and illuminating a change odor absorber indicator for a second predetermined successful time period after illuminating the check collector cell indicator.

31. The method of claim 20, with the method further comprising generating a negative diagnostics determination if an operational feature of the one or more operational features is operating outside the predetermined parameters.

32. The method of claim 20, with the diagnostic process checking for proper operation of a printed circuit board (PCB) of the air cleaner.

33. The method of claim 20, with the diagnostic process comparing one or more current operating values to one or more predetermined operating value ranges.

34. The method of claim 20, with the diagnostic process checking for one or more correct write operations to a memory.

35. The method of claim 20, with the diagnostic process checking for one or more correct write operations to a programmable read-only memory (PROM).

36. The method of claim 20, with the diagnostic process checking for one or more correct write operations to a programmable read-only memory (PROM) by a check collector cell indicator switch and by a change odor absorber indicator switch.

37. The method of claim 20, with the diagnostic process checking whether a collection cell is installed.

38. The method of claim 20, with the diagnostic process checking whether an odor absorber is installed.

39. An air cleaner diagnostic process, comprising:
receiving a predetermined diagnostic initiation sequence in the air cleaner;
initiating a diagnostics process for one or more operational features of the air cleaner in response to the predetermined diagnostic initiation sequence;
generating a positive diagnostics determination if the one or more operational features are operating within predetermined parameters; and
generating a negative diagnostics determination if an operational feature of the one or more operational features is operating outside the predetermined parameters.

40. The method of claim 39, with the predetermined diagnostic initiation sequence comprising an external command.

41. The method of claim 39, with the predetermined diagnostic initiation sequence comprising a predetermined control sequence.

42. The method of claim 39, with the predetermined diagnostic initiation sequence comprising a predetermined control sequence combined with provision of electrical power to the air cleaner.

43. The method of claim 39, with the method further comprising storing the positive diagnostics determination.

44. The method of claim 39, with the method further comprising generating a positive diagnostics display if the positive diagnostics determination is generated and generating a negative diagnostics display if the negative diagnostics determination is generated.

45. The method of claim 39, with the method further comprising generating a first positive diagnostics display for a first predetermined successful time period if the positive diagnostics determination is generated and generating a second positive diagnostics display for a second predetermined successful time period after generating the first positive diagnostics display.

46. The method of claim 39, with the method further comprising illuminating a first positive diagnostics indicator for a first predetermined successful time period if the positive diagnostics determination is generated and illuminating a second positive diagnostics indicator for a second predetermined successful time period after illuminating the first positive diagnostics indicator.

47. The method of claim 39, with the method further comprising illuminating a check collector cell indicator for a first predetermined successful time period if the positive diagnostics determination is generated and illuminating a change odor absorber indicator for a second predetermined successful time period after illuminating the check collector cell indicator.

48. The method of claim 39, with the diagnostic process checking for proper operation of a printed circuit board (PCB) of the air cleaner.

49. The method of claim 39, with the diagnostic process comparing one or more current operating values to one or more predetermined operating value ranges.

50. The method of claim 39, with the diagnostic process checking for one or more correct write operations to a memory.

51. The method of claim 39, with the diagnostic process checking for one or more correct write operations to a programmable read-only memory (PROM).

52. The method of claim 39, with the diagnostic process checking for one or more correct write operations to a programmable read-only memory (PROM) by a check collector cell indicator switch and by a change odor absorber indicator switch.

53. The method of claim 39, with the diagnostic process checking whether a collection cell is installed.

54. The method of claim 39, with the diagnostic process checking whether an odor absorber is installed.
